(19) United States
(12) Patent Application Publication
(10) Pub. No.: US 2003/0110821 A1
(43) Pub. Date: Jun. 19, 2003

(54) Process for manufacturing fertilizer

(76) Inventors: Lawrence Alan Peacock, Minnetonka, MN (US); Donald R. Clark, Tampa, FL (US)

Correspondence Address: Jeffrey L. Skelton, Cargill, Incorporated, P.O. Box 5624, Minneapolis, MN, 55440-5624, US

(21) Appl. No.: 10/268,167

(22) Filed: Oct. 10, 2002

Related U.S. Application Data
(60) Provisional application No. 60/328,905, filed on Oct. 11, 2001.

(51) Int. Cl. C05B 1/00

(52) U.S. Cl. 71/33

(57) ABSTRACT

A method for preparing a granular fertilizer composition that includes reacting a phosphoric acid stream with ammonia in a pipe cross reactor to form a molten slurry, and discharging the molten slurry into a granulator to form the granular fertilizer composition. The phosphoric acid stream includes greater than 0.6 wt. % magnesium oxide, based upon the total weight of the reactant stream.

### RELATED APPLICATION

This Application claims the benefit of U.S. Provisional Application 60/328,905 filed Oct. 11, 2001

### TECHNICAL FIELD

This invention relates to preparing granular fertilizer from phosphoric acid having a high magnesium oxide content.

### BACKGROUND

Standard technology for preparing granular fertilizers, such as monoammonium phosphate (MAP) and diammonium phosphate (DAP), utilizes a pre-neutralizer tank to ammoniate phosphoric acid. Increasingly, phosphoric acid feedstocks contain a high concentration of magnesium oxide, resulting from the acidulation of high magnesium content phosphate ore. Ammoniation of phosphoric acid having a high content of magnesium oxide under standard conditions results in a highly viscous slurry, which can be difficult to pump and granulate. In addition to being difficult to pump, the viscous slurry can plug inlet lines to a granulator, causing major operational down time. Once in a granulator, the viscous slurry tends to stay on the surface of the rolling bed, leading to overgranulation and/or an excessive amount of oversize material in the fertilizer output from the granulator.

An additional drawback to using high magnesium oxide-content phosphoric acid with the standard pre-neutralizer technology is that the resulting fertilizer has a high moisture content, which results in excessive caking of the product. In order to combat this caking effect, anti-caking coatings are extensively used to prevent moisture migration and the subsequent setup of stored fertilizers. Consequently, there is a need for improved fertilizer granulation technology that is tolerant of high magnesium oxide-content phosphoric acid.

### SUMMARY

In general, the invention relates to a method for preparing granular fertilizers, such as MAP and DAP, from phosphoric acid having a high magnesium oxide content. The method includes reacting a phosphoric acid stream containing greater than 0.6 wt. % magnesium oxide, based upon the total weight of the phosphoric acid stream, with ammonia in a pipe cross reactor to form a molten slurry, and discharging the molten slurry into a granulator.

Use of the pipe-cross reactor process produces fertilizers compositions having reduced moisture content (based on measurements of both free and bound water). Preferably, the moisture content is no greater than about 0.5 wt. %. An added advantage of moisture reduction in the granular fertilizer product is that the use of special coatings to prevent moisture migration and caking is diminished.

Another advantage of the pipe-cross reactor is its very short retention time (i.e., the residence time of the product stream within the reactor) compared to the retention time required when using a typical pre-neutralizer tank (seconds vs. 30-60 minutes). This short retention time makes a pipe-cross reactor particularly suitable for use in a continuous process for preparing granular fertilizer.

The method also provides more formulation freedom because the pipe-cross reactor is more tolerant of varying magnesium content in the feedstock. As a result, the process can produce ammonium phosphate fertilizer product that falls within acceptable specification ranges, despite varying purity of the phosphoric acid feedstock.

The details of one or more embodiments of the invention are set forth in the accompanying drawings and the description below. Other features, objects, and advantages of the invention will be apparent from the description and drawings, and from the claims.

### DESCRIPTION OF DRAWING

FIG. 1 is a schematic drawing showing one embodiment of a process for preparing granular fertilizer from high magnesium oxide-containing phosphoric acid.

### DETAILED DESCRIPTION

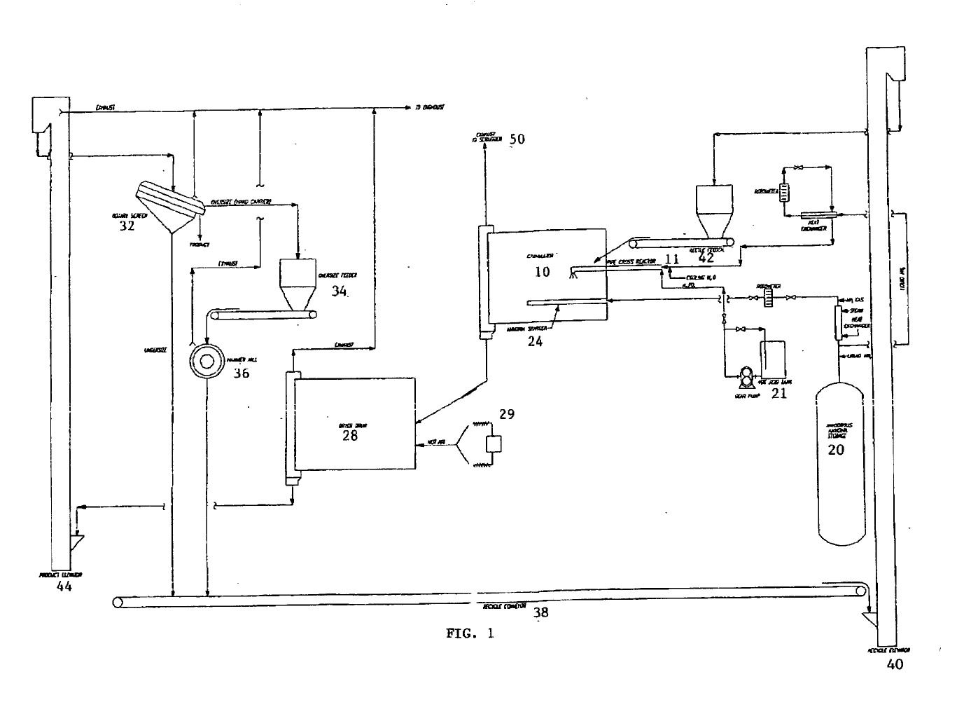

Referring to FIG. 1, there is shown a continuous process for preparing a granular fertilizer composition, such as monoammonium phosphate (MAP) and diammonium phosphate (DAP), or a combination thereof from phosphoric acid having a high magnesium oxide content. As shown in FIG. 1, a phosphoric acid solution having a magnesium oxide concentration of greater than 0.6 wt. %, based upon total weight of the reactant stream, is fed from a tank 21 into a pipe-cross reactor 11 of conventional design, where it is treated with anhydrous ammonia, supplied from a storage tank 20, to form a molten slurry. The molten slurry is then discharged into a rotating drum granulator 10 from the pipe-cross reactor 11; alternatively, the molten slurry could be discharged into a fluidized bed reactor. Any volatiles emitted from the granulator are fed to a scrubber 50 where they are treated to remove particles and then vented to the atmosphere. As the granulator rotates, the granular fertilizer composition is subjected to an ammonia sparge using an under-bed ammonia sparger 24 supplied with anhydrous ammonia from a storage tank 20. The concentration of ammonia is selected to achieve a nitrogen to phosphate (N/P) ratio of about 1.0 (in the case of MAP) or about 2.0 (in the case of DAP), at which point insoluble fertilizer particles form and aggregate.

Following the ammonia sparge, the particles are dried in a heated drying drum 28 to remove moisture and any other volatile material using heat supplied from a natural gas burner 29. Following drying, the particles are transported, via a product elevator 44, to a rotary screen 32 equipped with one or more particle sizing screens. Rotary screen 32 separates particles that are too large and too small, relative to a pre-determined target size, from the product stream. The oversize particles are charged to a belt feeder 34 and then fed to a hammer mill 36. Hammer mill 36 grinds the oversize particles to reduce their size. The ground particles are then recycled via recycle conveyor 38 and recycle elevator 40 and fed via belt recycle feeder 42 back to granulator 10. Rotary screen 32 likewise supplies undersize particles to recycle conveyor 38 where they join the oversize particles and form the raw material for granulator 10. Following separation of the oversize and undersize particles, the resulting product stream, which contains particles satisfying the pre-determined target size, are collected and stored. Any volatiles emitted during the particle sizing process, as well as volatiles emitted from drying drum 28, hammer mill 36, and product elevator 44, are fed to a baghouse where particles are collected and then the gases treated and vented to the atmosphere.

Other ingredients may be added to the fertilizer particles. Examples include micronutrients (e.g., zinc, manganese, iron, copper, molybdenum, boron, chloride, cobalt, sodium, and combinations thereof), and secondary nutrients (e.g., sulfur, calcium, magnesium, and combinations thereof). The micronutrients and secondary nutrients may be supplied in elemental form or in the form of salts (e.g., sulfates, nitrates, halides, oxides, etc.).

It is also possible, following particle formation, to apply one or more encapsulating coatings to the particles. Examples of suitable encapsulating coatings are known in the art and include, for example, polymeric coatings that degrade over time following application to soil. Anti-caking coatings can be applied to further prevent moisture migration and the subsequent setup of stored fertilizers.

### EXAMPLES

DAP was manufactured in accordance with the above-described process using 40 wt. % P₂O₅. The magnesium oxide level of the P₂O₅ was adjusted such that it ranged between 0.7 and 1.1 wt. %. The results are reported in Table 1, below, as Examples 1-3. For the sake of comparison, DAP was also manufactured using a pre-neutralizer at two different retention times. These results are reported in Table 1 as CE 1-6. The results demonstrate that the pipe cross reactor produces DAP having reduced moisture content using lower retention times compared to processes using a pre-neutralizer.

TABLE 1

| DAP | | | | Free | Bound | Retention |
|---|---|---|---|---|---|---|
| Products | N | P₂O₅ | MgO | H₂O | H₂O | Time (min) |
| Example 1 | 18.3 | 46.6 | 0.720 | 0.44 | 5.21 | <1 |
| Example 2 | 18.2 | 46.5 | 0.860 | 1.03 | 4.94 | <1 |
| Example 3 | 18.3 | 46.9 | 1.100 | 0.44 | 4.78 | <1 |
| CE 1 | 18.2 | 47.6 | 1.100 | 0.64 | 6.53 | 60 |
| CE 2 | 18.3 | 46.9 | 0.875 | 1.10 | 6.84 | 60 |
| CE 3 | 18.2 | 47.2 | 1.000 | 1.30 | 7.41 | 60 |
| CE 4 | 17.9 | 47.1 | 0.970 | 1.05 | 7.37 | 30 |
| CE 5 | 18.2 | 48.5 | 1.100 | 1.50 | 7.75 | 30 |
| CE 6 | 18.2 | 47.7 | 0.900 | 0.90 | 6.03 | 30 |

The DAP products of Examples 1-3 and CE 1-6 were coated with an anti-caking oil (available from ARR-MAZ Products, Tampa, Fla.) and subjected to small bag coating tests for a period of six months using the IFDC procedure S-106 (modification of TVA procedure). Approximately 50 lb. of each DAP product were heated to 190° F. in a fluid bed, transferred to the appropriate coating drum, and spray coated at a rate of 34.82 g/ton with the coating material. Immediately after coating, the temperature was measured, and each material was transferred to 16 lb. bags (6″×13″) at 3 lb./bag and sealed. Each of these bags was then placed in another bag and sealed. These sealed bags were placed in stacks of eight with sufficient weight to provide a pressure of 4 psi on the bags. These bags were sampled at 0, 1, 2, 3, and 6 months storage under weight according to the IFDC procedure. The results of these caking tests, reported in Table 2, indicate less product caking overall for the material prepared using the pipe cross reactor (Examples 1-3) compared to the material prepared using a pre-neutralizer (Comparative Examples (CE) 1-6).

TABLE 2

| DAP Products | Bag Set |
|---|---|
| Example 1 | none |
| Example 2 | none |
| Example 3 | L-1, 2 |
| CE 1 | L-2 |
| CE 2 | L-0, 2, 3, 6 |
| CE 3 | L-0 |
| CE 4 | L-1 |
| CE 5 | L-0 |
| CE 6 | none |

Key:
Bag set was qualitatively measured-L = light; M = medium; H = hard. Numbers following letter are the month sample with that set (e.g., L-0, 1, 2, 3, 6 means light set initially, and for 1, 2, 3, and 6 month samples).

A number of embodiments of the invention have been described. Nevertheless, it will be understood that various modifications may be made without departing from the spirit and scope of the invention. Accordingly, other embodiments are within the scope of the following claims.

What is claimed is:

1. A method for preparing a granular fertilizer composition comprising:
(a) reacting a phosphoric acid stream with ammonia in a pipe cross reactor to form a molten slurry, said phosphoric acid stream comprising greater than 0.6 wt. % magnesium oxide, based upon the total weight of the reactant stream; and
(b) discharging said molten slurry into a granulator.

2. A method according to claim 1 wherein said granular fertilizer composition comprises monoammonium phosphate.

3. A method according to claim 1 wherein said granular fertilizer composition comprises diammonium phosphate.

4. A method according to claim 1 wherein said reactant stream comprises at least 0.7 wt. % magnesium oxide.

5. A method according to claim 1 wherein said reactant stream comprises at least 0.8 wt. % magnesium oxide.

6. A method according to claim 1 wherein said reactant stream comprises at least 1.0 wt. % magnesium oxide.

7. A method according to claim 1 wherein said reactant stream comprises at least 1.1 wt. % magnesium oxide.

8. A method according to claim 1 wherein said granular fertilizer composition has a moisture content no greater than about 0.5 wt. %.

9. A method according to claim 1 wherein said granular fertilizer composition is substantially uncaked.

10. A method according to claim 1 wherein said granulator comprises a rotating granulation drum.
